(19) United States
(12) Patent Application Publication
(10) Pub. No.: US 2007/0289097 A1
(43) Pub. Date: Dec. 20, 2007

(54) Mechanical hinge

(75) Inventor: Ricky Barnett, St. Albans (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/453,568

(22) Filed: Jun. 14, 2006

(51) Int. Cl. E05D 11/08

(52) U.S. Cl. 16/342

(57) ABSTRACT

A hinge for use in an electronic device has an inner hinge part and an outer hinge part for providing rotatability between two device parts, allowing the device to open and close, for example. The inner hinge part has a peripheral surface defining the axis for rotation and a through channel along the axis for cable routing from one device part to another, for example. The peripheral surface of the inner hinge part has a groove substantially perpendicular to the rotation axis. On the outer hinge part, a ball bearing attached to one end of a spring is used to engage with the groove. The spring is disposed in a channel in the outer hinge part with another end of the spring secured on the outer part by a pin. One or more indents on the groove enable click and stop positions of the hinge.

### FIELD OF THE INVENTION

The present invention relates generally to a hinge and, more particularly, to a hinge that has a channel to feed cables, wires, optical fibers or the like therethrough.

### BACKGROUND OF THE INVENTION

Many electronic devices have two device parts connected through one or more hinges so as to allow the devices to open or close. For example, a mobile phone with a clamshell design has a cover and a base part connected by a hinge. The cover usually includes a display. In order to feed information and electrical power from the base part to the display, signal lines and power cables must be fed from the base part to the cover. It is desirable and advantageous that a channel is provided in the hinge so that those signal lines and power cables can be fed through the channel.

### SUMMARY OF THE INVENTION

The present invention provides a hinge having an inner part and an outer part for providing rotatability to an electronic device having two device parts, allowing the device to open and close, for example. The inner part has a peripheral surface defining the axis for rotation and a through channel along the axis for cable routing from one device part to another, for example. The peripheral surface of the inner part has a groove substantially perpendicular to the rotation axis and one or more indents along the groove. On the outer part, a ball bearing attached to one end of a spring is used to engage with the groove. The spring is disposed in a channel in the outer part and another end of the spring is secured on the outer part by a pin.

Thus, the first aspect of the present invention provides a hinge module which comprises:

a first hinge part;

a second hinge part mechanically coupled to the first hinge part, wherein

the first hinge part comprises:
a through channel along a body axis;
a peripheral surface outside the through channel;
a groove on the peripheral surface substantially perpendicular to the body axis, and
the second hinge part comprises:
a first end and an opposing second end;
a through hole on the first end, the through hole having an inner surface dimensioned to engage with the peripheral surface of the first hinge part so that the second hinge part can be rotated relative to the first hinge part about the body axis;
a channel having a first channel end extended through the inner surface of the through hole, and a second channel end extended toward the second end;
a spring disposed in the channel, the spring having a first spring end located near the first channel end and a second spring end located at the second channel end, the second spring end secured by a pin;
a protruding member, such as a ball bearing, attached to the first spring end, at least part of the protruding member protruding into the through hole for engaging with the groove on the peripheral surface of the first hinge part. The first hinge part has one or more indents located along the groove, and the indents has a depth greater than the depth of the groove such that when the second hinge part is rotated relative to the first hinge part, the protruding member may protrude further into the through hole for engaging with the indents.

The first hinge part can have a cylindrical body or a conical body to define the body axis and the inner diameter of the second hinge part is dimensional to fit the cylindrical or conical body for providing rotatability.

The second aspect of the present invention provides a method which provides:

rotatably engaging a first hinge part having a peripheral surface to a second hinge part having a through hole, wherein the peripheral surface of the first hinge part defines a body axis and the through hole of the second hinge part has an inner surface dimensioned to engage with the peripheral surface so as to allow the first hinge part and the second hinge part to rotate relative to one another about the body axis of the first hinge part;

providing on the first hinge part a through channel along the body axis and a groove on the peripheral surface substantially perpendicular to the body axis, and providing on the second hinge part a channel having an opening through the inner surface of the through hole;

disposing a protruding member in the channel near the opening so that at least part of the protruding member protrudes into the inner surface to engage with the groove; and

urging the protruding member to press against the groove in a direction substantially perpendicular to the body axis, wherein a spring can be disposed in the channel for urging the protruding member, such that the protruding member is attached to a first spring end and a pin is attached to the second spring end for securing the second spring end, and wherein the groove has one or more indents so as to allow the protruding member to protrude further into the through hole for engaging with the indents when the second hinge part is rotated relative to the first hinge part.

The third aspect of the present invention provides an electronic device which comprises:

a first device part;

a second device part;

at least a hinge mechanically coupling the first device part to the second device part, the hinge comprising:
a first hinge part attached to the first device part;
a second hinge part attached to the second device part, wherein

the first hinge part comprises:
a through channel along a body axis;
a peripheral surface outside the through channel;
a groove on the peripheral surface substantially perpendicular to the body axis with one or more indents on the groove, and

the second hinge part comprises:
a first end and an opposing second end;
a through hole on the first end, the through hole having an inner surface dimensioned to engage with the peripheral surface of the first hinge part so that the second hinge part can be rotated relative to the first hinge part about the body axis;
a channel having a first channel end extended through the inner surface of the through hole, and a second channel end extended toward the second end;
a spring disposed in the channel, the spring having a first spring end located near the first channel end and a second spring end located at the second channel end; and
a protruding member attached to the first spring end, at least part of the protruding member protruding into the through hole for engaging with the groove on the peripheral surface of the first hinge part; and

a plurality of signal lines between the first and second device parts, wherein the signal lines are routed through the through channel in the first hinge part. The signal lines can be electrically conducting wires for conveying electronic signals, at least one electrically conducting wire for conveying electrical power and optical fibers for conveying optical signals.

The fourth aspect of the present invention provides a hinge module which comprises:

means for providing rotatability between a first hinge part and a second hinge part, the first hinge part having a peripheral surface defining a body axis, the second hinge part comprising a through hole having an inner surface, the inner surface dimensioned to engage with the peripheral surface so as to allow the second hinge part to rotate relative to the first hinge part about the body axis for providing said rotatability;

means for channeling signal lines between two device parts mechanically coupled to the first and second hinge parts, the channeling means made through the first hinge part along the body axis;

means for guiding said rotatability, comprising:
a protruding means, disposed in the second hinge part, for protruding into the through hole; and
a groove on the peripheral surface substantially perpendicular to the body axis for engaging with the protruding means, with one or more indents along the groove; and

means for urging the protruding means to press against the groove.

The hinge of the present invention offers many advantages. The hinge enables a thinner product and it can be made small or large. The hinge can be used on devices of different types: clamshell devices, folding devices and twisting products. The through channel along the body axis of the inner hinge part accommodates cable routing through the hinge between two device parts of an electronic device. Cable routing can be done from left or right of the through channel, depending on the arrangement of the cabling of the device parts. The through channel on the inner hinge part can also be used to accommodate a joystick, for example. The hinges are easy to assemble and are reusable due to their modular nature.

The present invention will become apparent upon reading the description taken in conjunction with FIGS. 1 to 15.

### BRIEF DESCRIPTION OF THE DRAWINGS

FIG. 1 shows a hinge, according to one embodiment of the present invention.

FIG. 2 shows a plan view of a first hinge part of the hinge.

FIG. 3 shows a side view of the first hinge part.

FIG. 4 shows a cross sectional view of the first hinge part.

FIG. 5 shows a different cross sectional view of the first hinge part.

FIG. 6 shows a plan view of a second hinge part of the hinge.

FIG. 7 shows a side view of the second hinge part.

FIG. 8 shows a cross sectional view of the second hinge part.

FIG. 9 shows a different cross sectional view of the second hinge part.

FIG. 10 shows a cross sectional view of the hinge.

FIG. 11a shows a different cross sectional view of the hinge.

FIG. 11b shows the cross sectional view of FIG. 11a with a different relative position between the first and second hinge parts.

FIG. 12a is a schematic representation of a device having a hinge, according to one embodiment of the present invention, in a closed position.

FIG. 12b is a schematic representation of the device of FIG. 12a in an open position.

FIG. 13a is a schematic representation of another device having a hinge, according to one embodiment of the present invention, in a closed position.

FIG. 13b is a schematic representation of the device of FIG. 13a in an open position.

FIG. 14a is a schematic representation of yet another device having a hinge, according to a different embodiment of the present invention, in an open position.

FIG. 14b is a schematic representation of the device of FIG. 14a in a closed position.

FIG. 15 shows signal lines between two devices part being routed through the channel of a first hinge part.

### DETAILED DESCRIPTION OF THE INVENTION

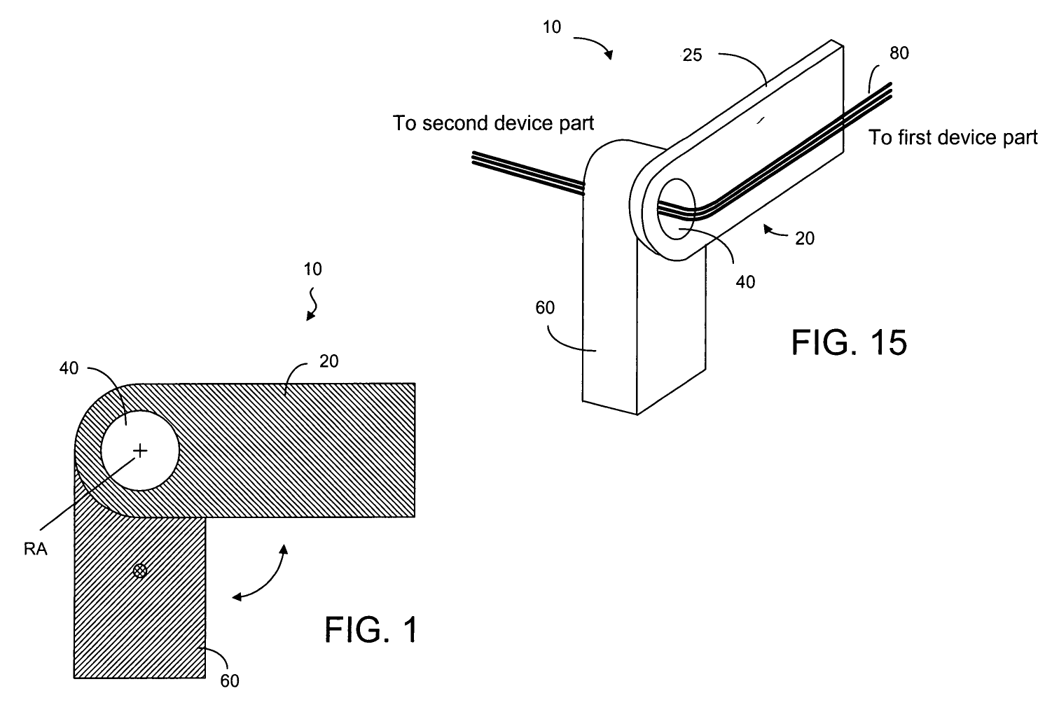

The hinge, according to one embodiment of the present invention, has two hinge parts which can be rotated relative to one another about a rotational axis. As shown in FIG. 1, the hinge 10 has a first hinge part 20 rotatably coupled to a second hinge part 60. The hinge 10 has a channel 40 along the rotational axis (RA) of the hinge.

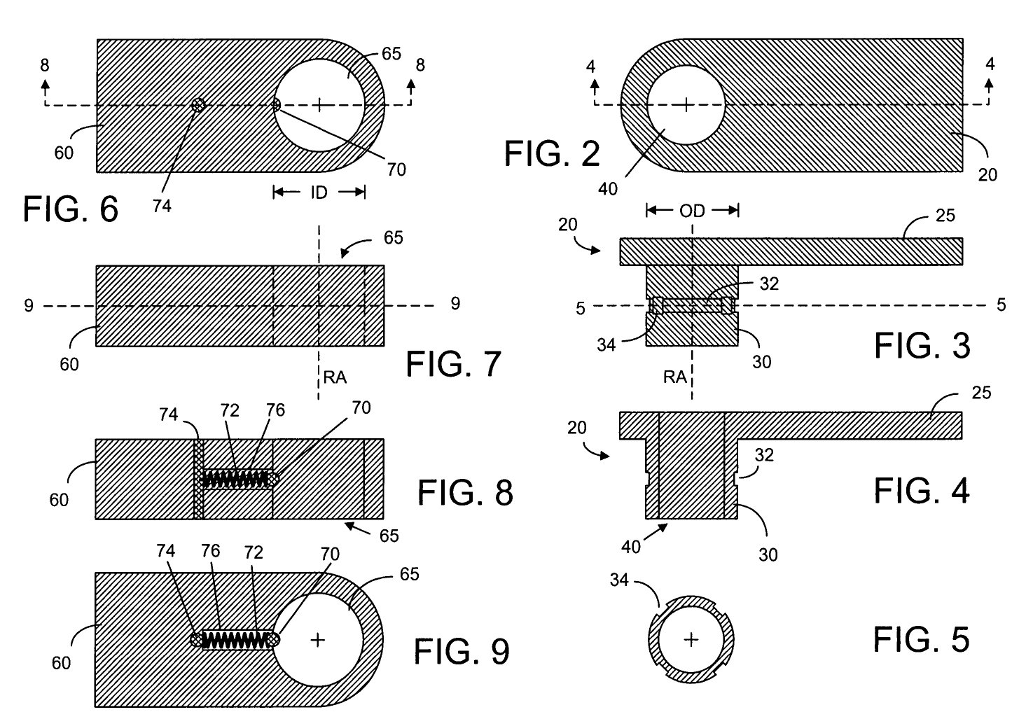

A plan view of the first hinge part 20 is shown in FIG. 2. As shown, the channel 40 is made on the first hinge part 20. A cross sectional view of the first hinge part 20 along the line 4,4 is shown in FIG. 4. A side view of the first hinge part 20 is shown in FIG. 3. As shown in FIG. 3, the first hinge part 20 has a joint 30 fixedly attached to a bracket 25. The joint 30 can be a cylindrical body with an outer diameter OD, for example. The cylindrical body defines the rotational axis RA. The joint 30 has a groove 32 along a circumference of the cylindrical body. As shown in FIG. 3, one or more indents 34 are made along the groove 32. A cross section view of the joint 30 along the line 5,5 is shown in FIG. 5.

FIG. 4 is a cross sectional view of the first hinge part 20 along the line 4,4 as indicated in FIG. 2. As can be seen in FIG. 4, the channel 40 is a hole made through both the joint 30 and the bracket 25 and the through hole is uniform in diameter in its entire length. However, the channel 40 can be irregular in shape, so long as it provides a sufficient passageway for the necessary signal lines and power wires between two device parts mechanically linked by the hinge.

FIG. 5 is a cross sectional view of the joint 30 along the groove 32 as indicated by the line 5,5 in FIG. 3. This cross section shows that the groove 32 covers the entire circumference of the joint 30 and there are four indents 34 along the grooves. However, the groove 32 can cover only a section of the circumference. The number of indents can be one, two or more and the indents do not have to be spaced out in equal distances.

A plan view of the first hinge part 60 is shown in FIG. 6. As shown, one end of the second hinge part 60 has a through hole 65. The inner diameter ID of the through hole 65 matches the outer diameter OD of the joint 30 in the first hinge part 20. The second hinge part 60 has a pin 74 to retain a spring 72 (see FIGS. 8 and 9), and a ball bearing 70 attached to the spring 72. A cross sectional view of the second hinge part 60 along the line 8,8 is shown in FIG. 8. A side view of the second hinge part 60 is shown in FIG. 7. The longitudinal axis of the through hole 65 is coincident to the rotational axis RA. A cross section view of the second hinge part along the line 9,9 is shown in FIG. 9.

FIG. 8 is a cross sectional view of the second hinge part 60 along the line 8,8 as indicated in FIG. 6. FIG. 8 is a different cross section view of the second hinge part 60 along the line 9,9 as indicated in FIG. 7. As can be seen in FIGS. 8 and 9, the through hole 65 is uniform in diameter in its entire length. The second hinge part 60 has a channel 76 to accommodate the spring 72. One end of the spring 72 is retained by the pin 74. The other end of the spring 72 is attached to the ball bearing 70 which is allowed to intrude into the through hole 65, so that the ball bearing 70 can be engaged in the groove 32 and the indents 34 on the joint 30 when the first and second hinge parts are assembled.

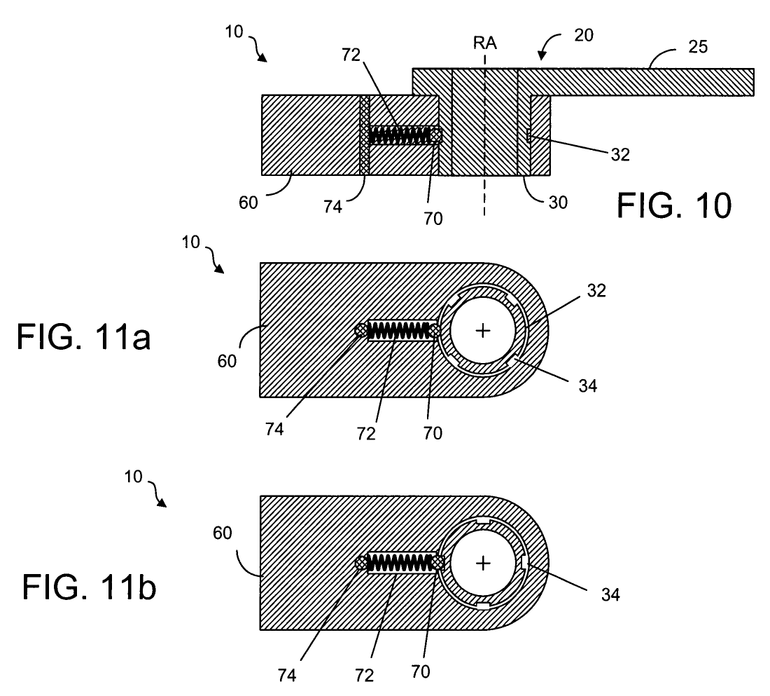

A cross sectional view of the assembled hinge 10, according to one embodiment of the present invention, is shown in FIG. 10. The view combines the cross sectional views of the first and second hinge parts as shown in FIGS. 4 and 8. As shown in FIG. 10, the groove 32 is dimensioned to engage with the ball bearing 70 while the first and second hinge parts are rotated relative to one another along the rotational axis RA.

A different cross sectional view of the assembled hinge 10 is shown in FIGS. 11a and 11b. Depending on the rotational angle between the first hinge part 20 and the second hinge part 60, the ball bearing 70 may be engaged with the groove 32 as shown in FIG. 11a, or with the indent 34 as shown in FIG. 11b.

The principle of operation of the hinge, according to the present invention, is that the compression spring 72 is positioned perpendicular to the rotational axis RA of the hinge 10 in order to force the ball bearing 70 against the groove 32 on the joint 30. As the first hinge part 20 rotates relative to the second hinge part 60, the ball bearing 70 is forced into deeper indents 34 around the groove 32. The groove and indent arrangement enables one or more click and stop positions of the hinge. The profile and depth of the indents determine the torque characteristics of the hinge.

By a suitable design of the indents, the torque to rotate in one direction from a stop position can be different from the torque to rotate in the opposite direction. With the hinge 10 as shown in FIGS. 1 to 11b, the rotation angle of the hinge can be 360 degrees. However, the rotation angle can be limited by a hindering mechanism disposed between the first and second hinge parts.

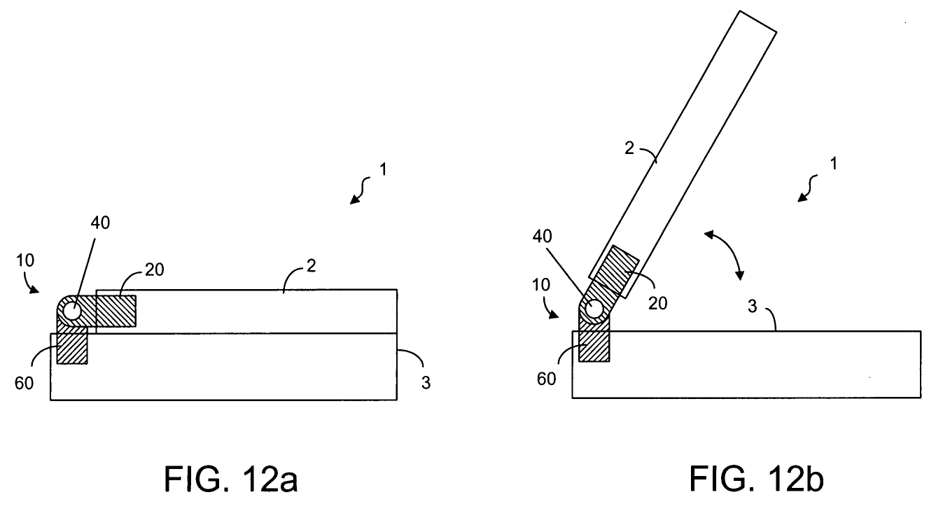

The hinge, according to the present invention, can be used to mechanically couple two parts of a device. For example, one or more hinges can be used to provide mechanical linkage between the cover and the engine of a mobile phone. The channel 40 can be used to feed electrical or optical lines between the cover and the engine. The hinge can have many different configurations to suit the design of the device. For example, one or more hinges 10 can be used on a clamshell device 1 as shown in FIGS. 12a and 12b. As shown, the first hinge part 20 is mounted on a first device part 2 and the second hinge part 60 is mounted on a second device 3. As can be seen from the side view of the device 1, the first device part 2 can be rotated against the second device part 3 to open or close the device 1.

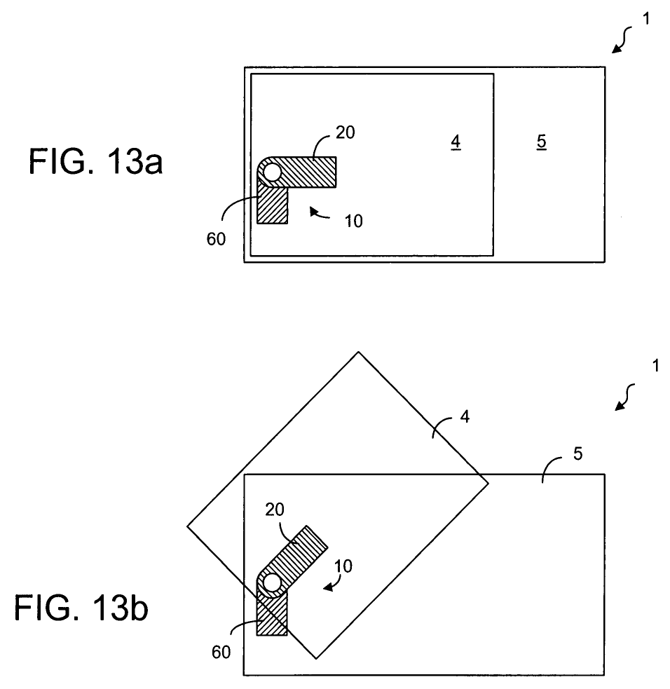

The same hinge can be used on a twist-type device. FIGS. 13a and 13b show a plan view of a twist-type device 1 having a first device part 4 and a second device part 5. The first device part 4 can be a cover or panel and the second device part 5 can be a base part. When the device is closed, the cover is substantially aligned with the base part, as shown in FIG. 13a. The cover can be laterally rotated against the base part to open the device, as shown in FIG. 13b.

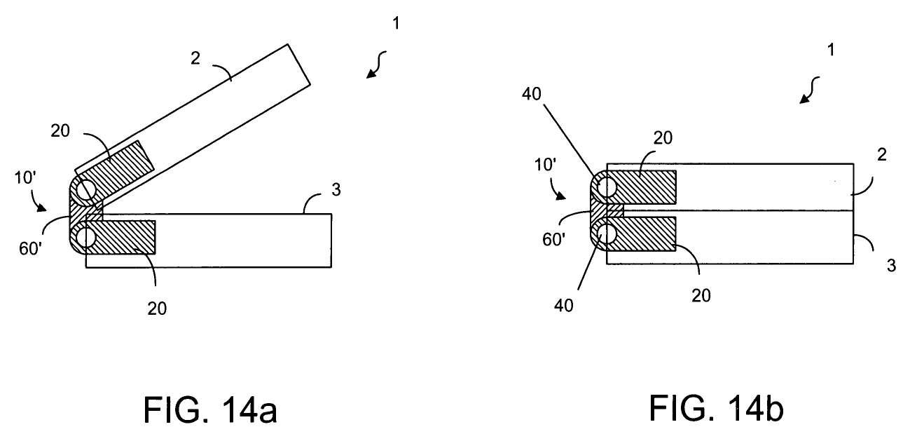

In a different configuration, the hinge part 60 has two through holes, two springs and two ball bearings (not shown) to be engaged with the joints 30 of two hinge parts 20. Each of the hinge parts 20 has a channel 40. As such, the hinge can be used on a fold-type device, as shown in FIG. 14a and 14b, which show an open position and a closed position, respectively.

When one or more hinges are used in an electronic device, such as those illustrated in FIGS. 12a to 14b, the channel 40 in the hinge can be used as a conduit for signal lines running between different device parts that are mechanically coupled by the hinges. As shown in FIG. 15, a plurality of signal lines 80 are routed through the channel 40 so that one end of the signal lines 80 can be disposed in the first device part and the other end disposed in the second device parts. The signal lines 80 may include electrically conductive wires and cables for conveying electrical signals and electrical power, optical fibers for conveying light and wires for providing electrical power between the device parts.

In sum, the hinge module of the present invention, comprises means for providing rotatability between a first hinge part and a second hinge part, the first hinge part having a peripheral surface defining a body axis, the second hinge part comprising a through hole having an inner surface, the inner surface dimensioned to engage with the peripheral surface so as to allow the second hinge part to rotate relative to the first hinge part about the body axis for providing said rotatability, and means for guiding said rotatability. The guiding means includes a protruding means, disposed in the second hinge part, for protruding into the through hole; and a groove on the peripheral surface substantially perpendicular to the body axis for engaging with the protruding means. The protruding means is depicted as a ball bearing. The hinge module also comprises means for channeling signal lines between two device parts mechanically coupled to the first and second hinge parts, the channeling means made through the first hinge part along the body axis and means for urging the protruding means to press against the groove. The channeling means is depicted as a through channel and the urging means is depicted as a spring having one end attached to the ball bearing and another end secured by a pin.

The hinge of the present invention offers many advantages. The hinge enables a thinner product and it can be made small or large. The through channel along the body axis of the inner hinge part accommodates cable routing through the hinge between two device parts of an electronic device. Cable routing can be done from left or right of the through channel, depending on the arrangement of the cabling of the device parts. The through channel on the inner hinge part can also be used to accommodate a joystick, for example.

Although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A hinge comprising:
a first hinge part;
a second hinge part mechanically coupled to the first hinge part, wherein the first hinge part comprises:
a through channel along a body axis;
a peripheral surface outside the through channel;
a groove on the peripheral surface substantially perpendicular to the body axis, and
the second hinge part comprises:
a first end and an opposing second end;
a through hole on the first end, the through hole having an inner surface dimensioned to engage with the peripheral surface of the first hinge part so that the second hinge part can be rotated relative to the first hinge part about the body axis;
a channel having a first channel end extended through the inner surface of the through hole, and a second channel end extended toward the second end;
a spring disposed in the channel, the spring having a first spring end located near the first channel end and a second spring end located at the second channel end; and
a protruding member attached to the first spring end, at least part of the protruding member protruding into the through hole for engaging with the groove on the peripheral surface of the first hinge part.

2. The hinge according to claim 1, wherein the groove on the peripheral surface has a groove depth, and wherein the peripheral surface further comprises one or more indents located along the groove, the indents having a depth greater than the groove depth such that when the second hinge part is rotated relative to the first hinge part, the protruding member may protrude further into the through hole for engaging with the indents.

3. The hinge according to claim 1, wherein the protruding member comprises a ball bearing.

4. The hinge according to claim 1, wherein the first hinge part comprises a cylindrical body.

5. The hinge according to claim 1, wherein the first hinge part comprises a conical body.

6. The hinge according to claim 1, further comprising a pin for securing the second spring end.

7. The hinge according to claim 1, wherein the first hinge part further comprises a bracket extended from a part of the peripheral surface.

8. A method comprising:
rotatably engaging a first hinge part having a peripheral surface to a second hinge part having a through hole, wherein the peripheral surface of the first hinge part defining a body axis and the through hole of the second hinge part has an inner surface dimensioned to engage with the peripheral surface so as to allow the first hinge part and the second hinge part to rotate relative to one another about the body axis of the first hinge part;
providing on the first hinge part a through channel along the body axis and a groove on the peripheral surface substantially perpendicular to the body axis, and providing on the second hinge part a channel having an opening through the inner surface of the through hole, and
disposing a protruding member in the channel near the opening so that at least part of the protruding member protrudes into the inner surface to engage with the groove.

9. The method of claim 8, further comprising:
urging the protruding member to press against the groove in a direction substantially perpendicular to the body axis.

10. The method of claim 9, furthering comprising:
disposing a spring in the channel for urging the protruding member.

11. The method of claim 10, wherein the spring has a first spring end and a second spring end, said method further comprising:
attaching the protruding member to the first spring end, and
securing the second spring end to the channel.

12. The method of claim 11, wherein the groove has a groove depth, said method further comprising:
providing one or more indents on the first hinge part along the groove, the indents having a depth greater than the groove depth so as to allow the protruding member to protrude further into the through hole for engaging with the indents when the second hinge part is rotated relative to the first hinge part.

13. An electronic device, comprising:
a first device part;
a second device part;
at least a hinge mechanically coupling the first device part to the second device part, the hinge comprising:
a first hinge part attached to the first device part;
a second hinge part attached to the second device part, wherein
the first hinge part comprises:
a through channel along a body axis;
a peripheral surface outside the through channel;
a groove on the peripheral surface substantially perpendicular to the body axis, and
the second hinge part comprises:
a first end and an opposing second end;
a through hole on the first end, the through hole having an inner surface dimensioned to engage with the peripheral surface of the first hinge part so that the second hinge part can be rotated with relative to the first hinge part about the body axis;
a channel having a first channel end extended through the inner surface of the through hole, and a second channel end extended toward the second end;
a spring disposed in the channel, the spring having a first spring end located near the first channel end and a second spring end located at the second channel end; and
a protruding member attached to the first spring end, at least part of the protruding member protruding into the through hole for engaging with the groove on the peripheral surface of the first hinge part; and
a plurality of signal lines between the first and second device parts, wherein the signal lines are routed through the through channel in the first hinge part.

14. The electronic device of claim 13, wherein the groove on the peripheral surface has a groove depth, and wherein the peripheral surface further comprises one or more indents located along the groove, the indents having a depth greater than the groove depth such that when the second hinge part is rotated relative to the first hinge part, the protruding member may protrude further into the through hole for engaging with the indents.

15. The electronic device of claim 13, wherein the signal lines comprise electrically conducting wires for conveying electronic signals.

16. The electronic device of claim 13, wherein the signal lines comprise at least one electrically conducting wire for conveying electrical power.

17. The electronic device of claim 13, wherein the signal lines comprises optical fibers for conveying optical signals.

18. A hinge module, comprising:
means for providing rotatability between a first hinge part and a second hinge part, the first hinge part having a peripheral surface defining a body axis, the second hinge part comprising a through hole having an inner surface, the inner surface dimensioned to engage with the peripheral surface so as to allow the second hinge part to rotate relative to the first hinge part about the body axis for providing said rotatability;
means for channeling signal lines between two device parts mechanically coupled to the first and second hinge parts, the channeling means made through the first hinge part along the body axis; and
means for guiding said rotatability, comprising:
a protruding means, disposed in the second hinge part, for protruding into the through hole; and
a groove on the peripheral surface substantially perpendicular to the body axis for engaging with the protruding means.

19. The hinge module of claim 18, further comprising:
means for urging the protruding means to press against the groove.

20. The hinge module of claim 18, wherein the groove on the peripheral surface has a groove depth, and wherein the peripheral surface further comprises one or more indents located along the groove, the indents having a depth greater than the groove depth such that when the second hinge part is rotated relative to the first hinge part, the protruding member may protrude further into the through hole for engaging with the indents.
